(19) United States
(12) Patent Application Publication
(10) Pub. No.: US 2025/0187672 A1
(43) Pub. Date: Jun. 12, 2025

(54) RAIL STRUCTURE FOR VEHICLE

(71) Applicants: Hyundai Motor Company, Seoul (KR); Kia Corporation, Seoul (KR)

(72) Inventors: Jaeha Shim, Hwaseong-si (KR); ChulHyun Kim, Hwaseong-si (KR); Juwon Lee, Hwaseong-si (KR); Janghoon Lee, Hwaseong-si (KR); Joonam Kim, Hwaseong-si (KR); SeungMin Kang, Hwaseong-si (KR); Jae Hoon Jung, Hwaseong-si (KR); Songjae Jeong, Hwaseong-si (KR); Sang Kyoung Han, Hwaseong-si (KR); Bong Guen Kwon, Hwaseong-si (KR)

(21) Appl. No.: 18/910,440

(22) Filed: Oct. 9, 2024

(30) Foreign Application Priority Data
Dec. 12, 2023 (KR) 10-2023-0179994

(51) Int. Cl. B62D 25/02

(52) U.S. Cl. CPC B62D 25/025

(57) ABSTRACT

An embodiment vehicle-body-integrated rail structure configured to be installed on a vehicle body and disposed in a door opening portion in the vehicle body is provided. The vehicle-body-integrated rail structure includes an upper rail disposed at an upper side of the door opening portion, a center rail disposed at a vehicle body rear center side of the door opening portion, and a lower rail disposed at a vehicle body lower side of the door opening portion, wherein rail openings are disposed in the upper rail and the lower rail and define sliding movement routes for a door.

### CROSS-REFERENCE TO RELATED APPLICATIONS

This application claims the benefit of Korean Patent Application No. 10-2023-0179994, filed on Dec. 12, 2023, which application is hereby incorporated herein by reference.

### TECHNICAL FIELD

The present disclosure relates to a rail structure for a vehicle.

### BACKGROUND

In general, a vehicle has an occupant compartment having a predetermined size in which a driver or an accompanied occupant may be seated, and occupant compartment opening/closing doors are installed on a vehicle body to open or close the occupant compartment.

In the case of a passenger vehicle, the occupant compartment opening/closing doors include a front door installed at a front side in a length direction of the vehicle and a rear door installed at a rear side in the length direction of the vehicle. The front door and the rear door are typically installed on the vehicle body so as to be rotatable using hinges.

In the case of a van in which multiple persons may be seated, the occupant compartment opening/closing doors slide forward and rearward in the length direction of the vehicle to open or close the occupant compartment.

In the case of the slide-type occupant compartment opening/closing door for a van, the occupant compartment opening/closing door is configured to move rearward in the length direction of the vehicle to open the occupant compartment and move forward in the length direction of the vehicle to close the occupant compartment. Therefore, the slide-type occupant compartment opening/closing door has an advantage in that a space required to open or close the door is smaller in the slide-type occupant compartment opening/closing door than in the hinged occupant compartment opening/closing door applied to the passenger vehicle and a door opening portion formed in the vehicle body may be completely opened even though the space required to open or close the door is small.

However, in the case of a plurality of steel press components, which is assembled to constitute a structure for providing a kinematic movement trajectory of the slide-type occupant compartment opening/closing door, the accumulation of tolerances occurring during a process of assembling the components degrades assembling quality of vehicle units.

In addition, in case that relative position dispersions between trajectories of two or more sliding rails occur to a degree higher than an assembling reference, a problem with the movement of the door occurs, and friction between the components causes abrasion or disconnection. In addition, in case that a gap or void is formed in a portion where the components are in contact with each other, there is a problem of deterioration in water tightness performance and NVH (noise, vibration, and harshness) performance.

### SUMMARY

The present disclosure relates to a rail structure for a vehicle. Particular embodiments relate to a vehicle-body-integrated rail structure for a vehicle, which is installed in a door opening portion and integrated into a single component that serves as a vehicle body.

Embodiments of the present disclosure can solve problems in the art, and an embodiment of the present disclosure provides a vehicle-body-integrated rail structure, which is configured as a single component, manufactured by an aluminum casting process method, precisely processed, and adopted as a part of a vehicle body, thereby basically preventing problems such as noise and abrasion that occur in a configuration in which a plurality of components is assembled.

An embodiment of the present disclosure provides a vehicle-body-integrated rail structure installed on a vehicle body and provided in a door opening portion formed in the vehicle body, the vehicle-body-integrated rail structure including an upper rail installed at an upper side of the door opening portion, a center rail installed at a vehicle body rear center side of the door opening portion, and a lower rail installed at a vehicle body lower side of the door opening portion, in which rail openings are formed in the upper rail and the lower rail and provide sliding movement routes for a door.

The lower rail may include a rail part in which the rail opening, which provides the sliding movement route for the door, is formed in a longitudinal direction of the vehicle body, a pillar connection part extending from the rail part toward an upper side of the vehicle body and connected to a pillar, a center cross member connection part extending from a lower end of the rail part toward a central portion of the vehicle body and connected to a center cross member of the vehicle body, and vehicle body connection parts extending from lower ends of two opposite sides of the rail part in the longitudinal direction of the vehicle body and connected to the vehicle body.

A protrusion may be formed on an inner surface of a lower portion of the rail opening and protrude toward the inside of the rail opening so that a bearing connected to a door arm is seated on the protrusion and rolls.

The center cross member connection part may be formed in a shape that is concave toward a lower side of the vehicle body so as to be connected to and overlap an end of the center cross member, and an end of the center cross member connection part may be connected to an end of the center cross member by a blind rivet.

The vehicle body connection part may be formed in a stepped tunnel shape so as to be connected to and overlap an end of the vehicle body, the vehicle body may be inserted into and connected to the inside of the stepped tunnel shape of the vehicle body connection part, an upper side of the vehicle body may be coupled to an upper side of the vehicle body connection part by a self-piercing rivet (SPR), and a lower side of the vehicle body may be coupled to a lower side of the vehicle body connection part by a blind rivet.

The pillar connection part may be formed in a stepped tunnel shape so as to be connected to and overlap an end of a B-pillar and an end of a C-pillar, the B-pillar may be inserted into and connected to the inside of the stepped tunnel shape of the pillar connection part, an outer side of the B-pillar may be connected to an outer side of the pillar connection part by a flow drill screw (FDS), an inner side of the B-pillar may be connected to an inner side of the pillar connection part by a blind rivet, the C-pillar may be inserted into and connected to the inside of the stepped tunnel shape of the pillar connection part, and the C-pillar may be coupled to the inside of the stepped tunnel shape of the pillar connection part by an SPR.

The upper rail may include a rail part in which the rail opening, which provides the sliding route for the door, is formed in a longitudinal direction of the vehicle body, a pillar connection part extending from the rail part toward a lower side of the vehicle body and connected to a pillar, a roof rail connection part extending from an upper end of the rail part toward a central portion of the vehicle body and connected to a roof rail of the vehicle body, and a vehicle body connection part extending from the upper end of the rail part in the longitudinal direction of the vehicle body and connected to the vehicle body.

The center rail may include a rail part in which a rail, which provides a sliding route for the door, is formed in a longitudinal direction of the vehicle body, a first pillar connection part extending from one end of the rail part toward upper and lower sides of the vehicle body and connected to a C-pillar of the vehicle, and a second pillar connection part extending from the other end of the rail part toward a rear side of the vehicle body.

The first pillar connection part may include a first upper pillar connection part extending from one end of the rail part toward the upper side of the vehicle body and connected to an upper portion of the C-pillar and a first lower pillar connection part extending from one end of the rail part toward the lower side of the vehicle body and connected to a lower portion of the C-pillar.

A closed cross-section portion configured as a cross-shaped bead may be formed between the first upper pillar connection part and the first lower pillar connection part.

According to an embodiment of the present disclosure, the vehicle-body-integrated rail may be produced as a single component by using an aluminum casting process method, which may eliminate in advance the factor of degradation of assembling quality due to tolerance that occurs at the time of assembling a plurality of components.

In addition, it is possible to prevent a dimension defect between components, an assembling defect, and deteriorations in water tightness performance and NVH performance caused by a gap and void between components.

In addition, it is possible to provide excellent trajectory dimension quality to the single component, which may solve a problem with the connection between the vehicle body component and the bearing, prevent the occurrence of noise, and reduce abrasion progression while the sliding door operates.

In addition, the vehicle-body-integrated rail, which constitutes the framework structure of the vehicle body and is configured in longitudinal/transverse/upward/downward directions, is provided, which may improve rigidity of the vehicle body.

### BRIEF DESCRIPTION OF THE DRAWINGS

FIG. 1 is a view illustrating a state in which a vehicle-body-integrated rail structure according to an embodiment of the present disclosure is installed on a vehicle body.

FIG. 2 is a top plan view illustrating a lower rail of the vehicle-body-integrated rail structure according to an embodiment of the present disclosure when viewed from the front side.

FIG. 3 is a top plan view illustrating the lower rail of the vehicle-body-integrated rail structure according to an embodiment of the present disclosure when viewed from the top side.

FIG. 4 is a top plan view illustrating the lower rail of the vehicle-body-integrated rail structure according to an embodiment of the present disclosure when viewed from the bottom side.

FIG. 5 is a cross-sectional view taken along line ‘A-A’ in FIG. 2.

FIG. 6 is a perspective view illustrating the lower rail of the vehicle-body-integrated rail structure according to an embodiment of the present disclosure.

FIG. 7 is an enlarged view when viewed from ‘A’ in FIG. 6.

FIG. 8 is an enlarged view when viewed from ‘B’ in FIG. 6.

FIG. 9 is an enlarged view when viewed from ‘C’ in FIG. 6.

FIG. 10 is an enlarged view when viewed from ‘D’ in FIG. 6.

FIG. 11 is a perspective view illustrating an upper rail of the vehicle-body-integrated rail structure according to an embodiment of the present disclosure.

FIG. 12 is a top plan view illustrating a center rail of the vehicle-body-integrated rail structure according to an embodiment of the present disclosure when viewed from the front side.

### DETAILED DESCRIPTION OF ILLUSTRATIVE EMBODIMENTS

Hereinafter, embodiments of the present disclosure will be described in detail with reference to the accompanying drawings so that those with ordinary skill in the art to which the present disclosure pertains may easily carry out the embodiments. Embodiments of the present disclosure may be implemented in various different ways and are not limited to the embodiments described herein.

In addition, the constituent elements having the same configurations in several embodiments will be assigned with the same reference numerals and described only in the representative embodiment, and only the constituent elements, which are different from the constituent elements according to the representative embodiment, will be described in other embodiments.

It is noted that the drawings are schematic and are not illustrated based on actual scales. Relative dimensions and proportions of parts illustrated in the drawings are exaggerated or reduced in size for the purpose of clarity and convenience in the drawings, and any dimension is just illustrative but not restrictive. Further, the same reference numerals designate the same structures, elements, or components illustrated in two or more drawings in order to exhibit similar characteristics. When one component is described as being positioned “above” or “on” another component, one component can be positioned “directly on” another component, and one component can also be positioned on another component with other components interposed therebetween.

The embodiments of the present disclosure specifically illustrate exemplary embodiments of the present disclosure. As a result, various modifications of the drawings are expected. Therefore, the embodiments are not limited to specific forms in regions illustrated in the drawings, and for example, include modifications of forms by the manufacture thereof.

Hereinafter, a vehicle-body-integrated rail structure according to an embodiment of the present disclosure will be described in detail with reference to the accompanying drawings.

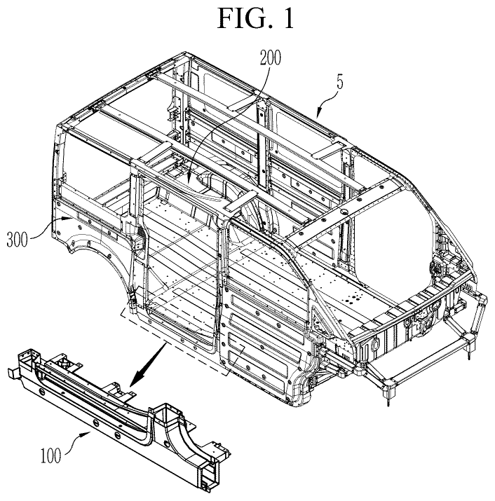

FIG. 1 is a view illustrating a state in which a vehicle-body-integrated rail structure according to an embodiment of the present disclosure is installed on a vehicle body.

With reference to FIG. 1, a vehicle-body-integrated rail structure according to an embodiment of the present disclosure may include an upper rail 200 installed between pillars, i.e., a B-pillar 8 and a C-pillar 7 provided at an upper side of a door opening portion formed in a vehicle body 5, a center rail 300 installed to connect vehicle body rear center sides of the door opening portion, i.e., upper and lower portions of the C-pillar 7, and extend toward a rear side of the vehicle body, and a lower rail 100 installed between pillars, i.e., the B-pillar 8 and the C-pillar 7. at a vehicle body lower side of the door opening portion.

Upper portions of two opposite ends of the lower rail 100 are respectively connected to a lower end of the B-pillar 8 and a lower end of the C-pillar 7, and lateral and central portions of the two opposite ends of the lower rail 100 are connected to a center cross member of the vehicle body 5. In addition, the lateral portions of the two opposite ends are directed toward the front and rear sides of the vehicle body 5 and connected to the vehicle body 5, such that a structure of the lower rail 100 constitutes the vehicle body 5 between the B-pillar 8 and the C-pillar 7.

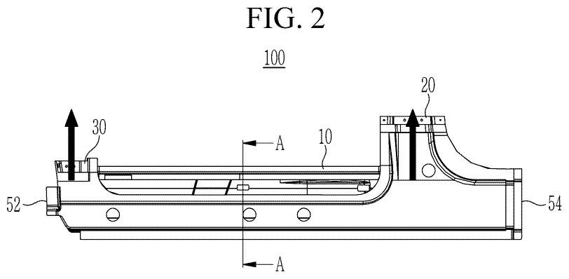

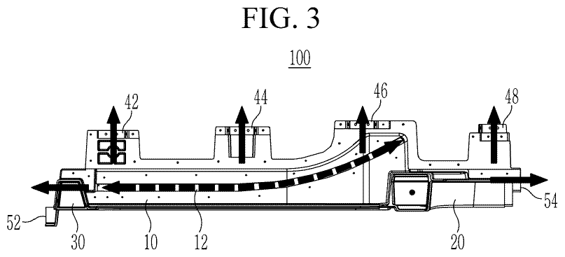

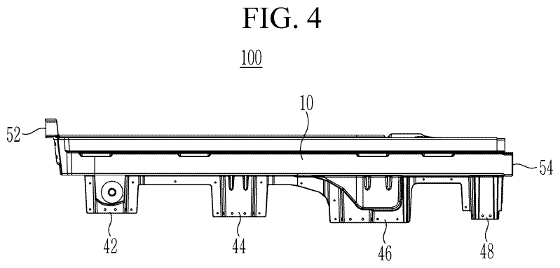

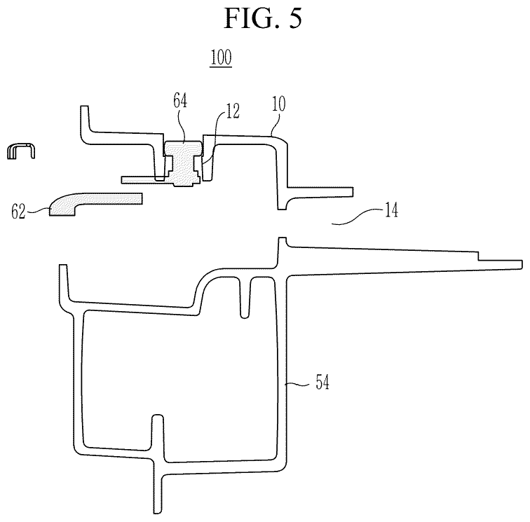

FIG. 2 is a top plan view illustrating a lower rail of the vehicle-body-integrated rail structure according to an embodiment of the present disclosure when viewed from the front side, FIG. 3 is a top plan view illustrating the lower rail of the vehicle-body-integrated rail structure according to an embodiment of the present disclosure when viewed from the top side, FIG. 4 is a top plan view illustrating the lower rail of the vehicle-body-integrated rail structure according to an embodiment of the present disclosure when viewed from the bottom side, and FIG. 5 is a cross-sectional view taken along line ‘A-A’ in FIG. 2.

With reference to FIGS. 2 to 4, in the vehicle-body-integrated rail structure according to an embodiment of the present disclosure, the lower rail 100 includes a rail part 10, pillar connection parts 20 and 30, and center cross member connection parts 42, 44, 46, and 48.

In addition, in the vehicle-body-integrated rail structure according to an embodiment of the present disclosure, the lower rail 100 may further include vehicle body connection parts 52 and 54, and the pillar connection parts 20 and 30 may include a B-pillar connection part 20 and a C-pillar connection part 30.

The rail part 10 is disposed between the B-pillar 8 and the C-pillar 7 and constitutes a central portion of the lower rail 100. A rail opening 12 is formed through upper and lower portions of the rail part 10 and provided in a longitudinal direction of the vehicle body 5. The rail opening 12 provides a sliding route for a door.

The rail opening 12 may be convex toward the outside of the vehicle body 5 in the longitudinal direction of the vehicle body 5. Therefore, when the door is opened, the door may move toward the outside of the vehicle body 5 while sliding along the rail opening 12 in a direction from the front side to the rear side of the vehicle body 5. On the contrary, when the door is closed, the door may move toward the inside of the vehicle body 5 while sliding along the rail opening 12 in a direction from the rear side to the front side of the vehicle body 5.

With reference to FIG. 5, a door arm 62 provided on the door may be connected to an inner surface of the lower portion of the rail opening 12. A bearing 64, which may roll, is provided on the door arm 62, and the bearing 64 may be seated in the rail opening 12.

Protrusions may be positioned on the inner surface of the lower portion of the rail opening 12 and protrude toward the inside of the rail opening 12 so that the bearing 64 may be seated on the protrusions and roll. The protrusions protrude from the inner surface of the rail opening 12 while facing each other. The bearing 64 is seated on the upper surfaces of the protrusions to prevent the door arm 62 from separating toward the lower portion of the rail opening 12.

As illustrated in FIGS. 3 and 4, the center cross member connection parts 42, 44, 46, and 48 are provided at a lower end of the rail part 10 and integrated with the rail part 10. The center cross member connection parts 42, 44, 46, and 48 may extend toward the central portion of the vehicle body 5 and be connected to the center cross member of the vehicle body 5 extending in a direction perpendicular to the longitudinal direction of the vehicle body 5. In the present embodiment, four center cross member connection parts 42, 44, 46, and 48 may be provided, and the center cross member connection parts 42, 44, 46, and 48 may be provided to correspond in number to the center cross members.

The center cross member connection parts 42, 44, 46, and 48 may each have a shape concavely stepped toward the lower side of the vehicle body 5 so as to be connected to and overlap an end of the center cross member. That is, the end of the center cross member may be seated on and connected to the concavely stepped portion of each of the center cross member connection parts 42, 44, 46, and 48.

The vehicle body connection parts 52 and 54 extend from the lower ends of the two opposite sides of the rail part 10 in the longitudinal direction of the vehicle body 5 and are integrated with the rail part 10. The vehicle body connection parts 52 and 54 may be connected to a side sill of the vehicle body 5 extending in the longitudinal direction of the vehicle.

The vehicle body connection parts 52 and 54 may each have a stepped tunnel shape so as to be connected to and overlap an end of the vehicle body 5. That is, the end of the side sill of the vehicle body 5 may be inserted into and connected to the inside of a stepped tunnel portion of each of the vehicle body connection parts 52 and 54.

The B-pillar connection part 20 extends from an upper end of a front side of the rail part 10 toward an upper side of the vehicle body 5 and is integrated with the rail part 10. The B-pillar connection part 20 may be connected to the B-pillar 8 of the vehicle body 5. In addition, the C-pillar connection part 30 extends from an upper end of a rear side of the rail part 10 toward the upper side of the vehicle body 5 and is integrated with the rail part 10. The C-pillar connection part 30 may be connected to the C-pillar 7 of the vehicle body 5.

The B-pillar connection part 20 and the C-pillar connection part 30 may respectively have stepped tunnel shapes so as to be connected to and overlap the end of the B-pillar 8 and the end of the C-pillar 7. That is, the B-pillar 8 and the C-pillar 7 may be respectively inserted into and connected to the inside of the stepped tunnel portion of the B-pillar connection part 20 and the stepped tunnel portion of the C-pillar connection part 30.

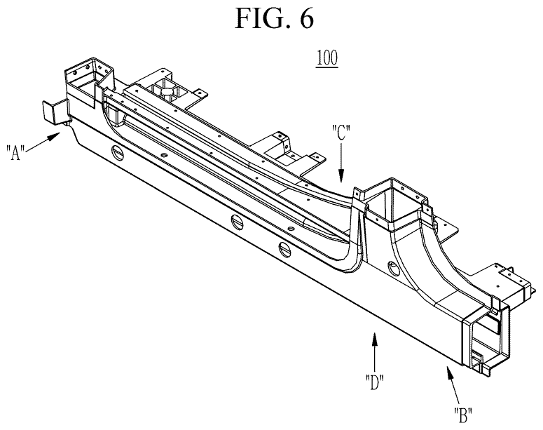

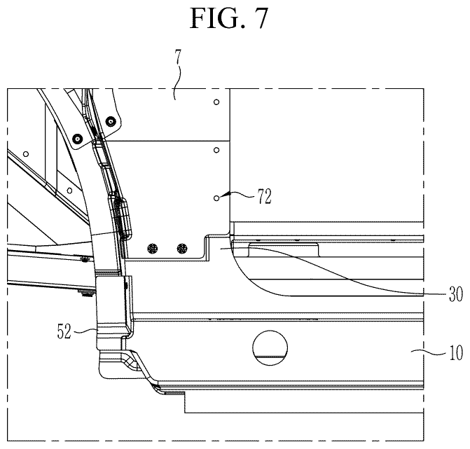

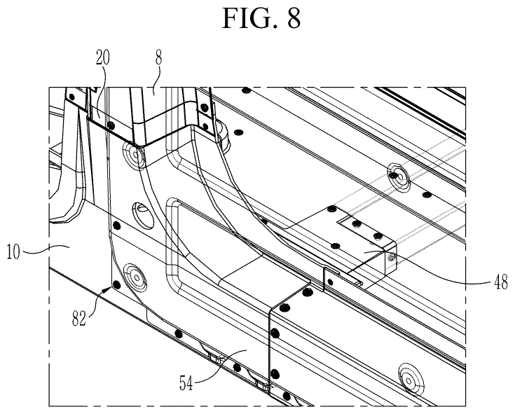

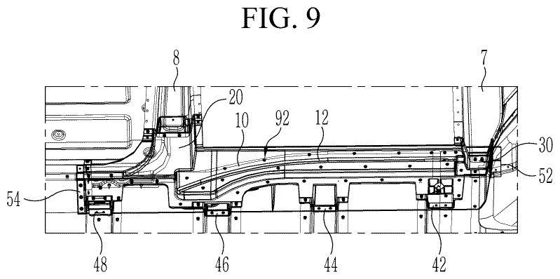

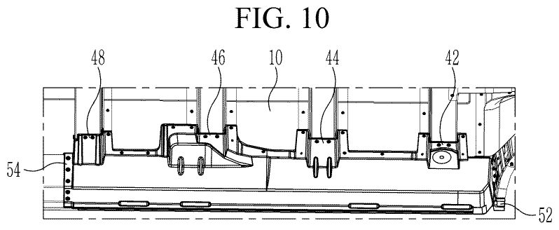

FIG. 6 is a perspective view illustrating the lower rail of the vehicle-body-integrated rail structure according to an embodiment of the present disclosure, FIG. 7 is an enlarged view when viewed from ‘A’ in FIG. 6, FIG. 8 is an enlarged view when viewed from ‘B’ in FIG. 6, FIG. 9 is an enlarged view when viewed from ‘C’ in FIG. 6, and FIG. 10 is an enlarged view when viewed from ‘D’ in FIG. 6.

With reference to FIGS. 6 and 7, the C-pillar connection part 30, which is integrated with the end of the rail part 10, extends in the direction perpendicular to the longitudinal direction of the vehicle body 5. The C-pillar connection part 30 is connected to the C-pillar 7 of the vehicle body 5. In addition, the vehicle body connection parts 52 and 54 integrated with the ends of the rail part 10 extend rearward in the longitudinal direction of the vehicle body 5 and are connected to the side sill of the vehicle body 5.

The C-pillar connection part 30 may have a stepped tunnel shape so as to be connected to and overlap an end of the C-pillar 7, and the C-pillar 7 may be inserted into and connected to the inside of the stepped tunnel portion. The C-pillar 7 may be coupled to the inside of the stepped tunnel shape of the C-pillar connection part 30 by a self-piercing rivet (SPR) 72. The coupling method using the SPR 72 uses a press-fitting method that facilitates automation and decreases working time without requiring a separate hole for a rivet.

In addition, the vehicle body 5 may be inserted into and connected to the inside of the stepped tunnel shapes of the vehicle body connection parts 52 and 54. The upper side of the vehicle body 5 may be coupled to the upper sides of the vehicle body connection parts 52 and 54 by the SPR 72.

With reference to FIGS. 6 and 8, the center cross member connection parts 42, 44, 46, and 48 and the B-pillar connection part 20, which are integrated at the end of the rail part 10, extend in the direction perpendicular to the longitudinal direction of the vehicle body 5, and the vehicle body connection parts 52 and 54 extend forward in the longitudinal direction of the vehicle body 5 and are connected to the vehicle body 5. The center cross member connection parts 42, 44, 46, and 48 and the B-pillar connection part 20 are connected to the center cross member and the B-pillar 8.

The B-pillar 8 may be inserted into and connected to the inside of the stepped tunnel portion of the B-pillar connection part 20. In this case, an outer side of the B-pillar 8 may be coupled to an outer side of the B-pillar connection part 20 by a flow drill screw (FDS) 82. In addition, an inner side of the B-pillar 8 may be coupled to an inner side of the B-pillar connection part 20 by a blind rivet 92. The FDS 82 may be provided as a plurality of FDSs 82. The FDS 82 is a screw having a screw thread formed on an outer surface thereof. The B-pillar 8 and the B-pillar connection part 20 may be coupled or detached by rotating the FDS 82.

With reference to FIGS. 6, 9, and 10, the center cross member connection parts 42, 44, 46, and 48 may each have a shape that is concave toward the lower side of the vehicle body 5 so as to be connected to and overlap the end of the center cross member.

The ends of the center cross member connection parts 42, 44, 46, and 48 may each be connected to the end of the center cross member by the blind rivet 92. The plurality of blind rivets 92 may be installed in the longitudinal direction of the center cross member connection parts 42, 44, 46, and 48 and coupled to the center cross member.

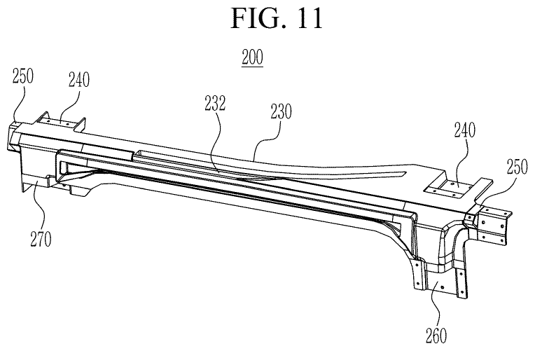

FIG. 11 is a perspective view illustrating the upper rail of the vehicle-body-integrated rail structure according to an embodiment of the present disclosure.

With reference to FIG. 11, the upper rail 200 may include a rail part 230, pillar connection parts 260 and 270, a roof rail connection part 240, and a vehicle body connection part 250. The pillar connection parts 260 and 270 may include a B-pillar connection part 260 and a C-pillar connection part 270.

The rail part 230 is disposed between the B-pillar and the C-pillar of the vehicle and constitutes the central portion of the upper rail 200. A rail opening 232 is formed through upper and lower portions of the rail part 230 and provided in the longitudinal direction of the vehicle body. The rail opening 232 provides a sliding route for the door. The rail opening 232 may be convex toward the outside of the vehicle body 5 in the longitudinal direction of the vehicle body 5.

Therefore, when the door is opened, the door may move toward the outside of the vehicle body 5 while sliding along the rail opening 232 in a direction from the front side to the rear side of the vehicle body 5. On the contrary, when the door is closed, the door may move toward the inside of the vehicle body 5 while sliding along the rail opening 232 in a direction from the rear side to the front side of the vehicle body.

The vehicle body connection parts 250 extend from the upper end of the two opposite sides of the rail part 230 in the longitudinal direction of the vehicle body 5 and are integrated with the rail part 230. The vehicle body connection parts 250 may be connected to the vehicle body 5 extending in the longitudinal direction of the vehicle.

The vehicle body connection parts 250 may have a stepped tunnel shape so as to be connected to and overlap an end of the vehicle body 5. That is, the ends of the vehicle body 5 may be inserted into and connected to the inside of the stepped tunnel portion of the vehicle body connection parts 250.

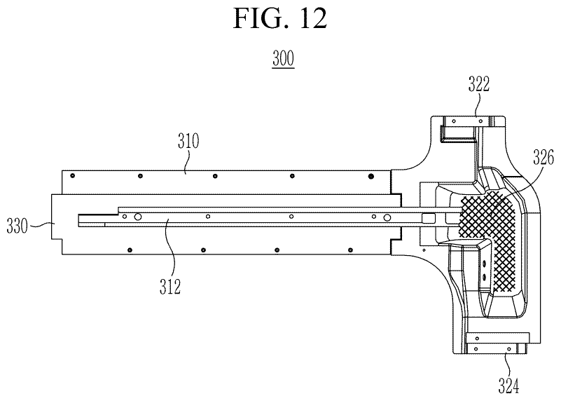

FIG. 12 is a top plan view illustrating the center rail of the vehicle-body-integrated rail structure according to an embodiment of the present disclosure when viewed from the front side.

With reference to FIG. 12, the center rail 300 includes a rail part 310, first pillar connection parts 322 and 324, and a second pillar connection part 330.

The rail part 310 is disposed between the B-pillar 8 and the C-pillar 7 of the vehicle and constitutes the central portion of the center rail 300. A rail 312 is provided on the rail part 310 in the longitudinal direction of the vehicle body 5, and the rail 312 provides a sliding route for the door. The rail 312 may have an opening shape opened at one side thereof so that the bearing connected to the door arm is inserted.

The rail 312 may be convex toward the outside of the vehicle body 5 in the longitudinal direction of the vehicle body 5. Therefore, when the door is opened, the door may move toward the outside of the vehicle body 5 while sliding along the rail 312 in a direction from the front side to the rear side of the vehicle body 5. On the contrary, when the door is closed, the door may move toward the inside of the vehicle body 5 while sliding along the rail 312 in a direction from the rear side to the front side of the vehicle body 5.

The first pillar connection parts 322 and 324 extend upward and downward from one end of the rail part 310, i.e., the front side of the vehicle body 5, and are connected to the C-pillar 7 of the vehicle. The first pillar connection parts 322 and 324 may include a first upper pillar connection part 322 extending toward the upper side of the vehicle body 5 and connected to the upper portion of the C-pillar 7 and a first lower pillar connection part 324 extending toward the lower side of the vehicle body 5 and connected to the lower portion of the C-pillar 7.

In addition, a closed cross-section portion 326 configured as a cross-shaped bead may be formed between the first upper pillar connection part 322 and the first lower pillar connection part 324. The closed cross-section portion 326 may have a shape recessed from surfaces of the first pillar connection parts 322 and 324 toward the vehicle body 5.

According to an embodiment of the present disclosure as described above, the vehicle-body-integrated rail may be produced as a single component by using an aluminum casting process method, which may eliminate in advance the factor of degradation of assembling quality due to tolerance that occurs at the time of assembling a plurality of components.

In addition, it is possible to prevent a dimension defect between components, an assembling defect, and deteriorations in water tightness performance and NVH performance caused by a gap and void between components.

In addition, it is possible to provide excellent trajectory dimension quality to the single component, which may solve a problem with the connection between the vehicle body component and the bearing, prevent the occurrence of noise, and reduce abrasion progression while the sliding door operates.

In addition, the vehicle-body-integrated rail, which constitutes the framework structure of the vehicle body and is configured in longitudinal/transverse/upward/downward directions, is provided, which may improve rigidity of the vehicle body.

While the exemplary embodiments of the present disclosure have been described, the embodiments of the present disclosure are not limited to the exemplary embodiments. The embodiments of the present disclosure cover all modifications that can be easily made from the embodiments of the present disclosure by those skilled in the art and considered as being equivalent to the embodiments of the present disclosure.

The following reference identifiers may be used in connection with the figures to describe various features of embodiments of the present disclosure.
5: Vehicle body
7: C-pillar
8: B-pillar
10, 230, 310: Rail part
12, 232: Rail opening
20: B-pillar connection part
30: C-pillar connection part
52, 54, 250: Vehicle body connection part
42, 44, 46, 48: Center cross member connection part
62: Door arm
64: Bearing
72: SPR
82: FDS
92: Blind rivet
100: Lower rail
200: Upper rail
300: Center rail
240: Roof rail connection part
250: Vehicle body connection part
260, 270: Pillar connection part
312: Rail
322, 324: First pillar connection part
330: Second pillar connection part
326: Closed cross-section portion

What is claimed is:

1. A vehicle-body-integrated rail structure configured to be installed on a vehicle body and disposed in a door opening portion in the vehicle body, the vehicle-body-integrated rail structure comprising:
an upper rail disposed at an upper side of the door opening portion;
a center rail disposed at a vehicle body rear center side of the door opening portion; and
a lower rail disposed at a vehicle body lower side of the door opening portion, wherein rail openings are disposed in the upper rail and the lower rail and define sliding movement routes for a door.

2. The vehicle-body-integrated rail structure of claim 1, wherein the lower rail comprises:
a rail part in which the rail opening is disposed in a longitudinal direction of the vehicle body;
a pillar connection part extending from the rail part toward an upper side of the vehicle body and connected to a pillar;
a center cross member connection part extending from a lower end of the rail part toward a central portion of the vehicle body and connected to a center cross member of the vehicle body; and
vehicle body connection parts extending from lower ends of two opposite sides of the rail part in the longitudinal direction of the vehicle body and connected to the vehicle body.

3. The vehicle-body-integrated rail structure of claim 2, wherein:
a protrusion is disposed on an inner surface of a lower portion of the rail opening and protrudes toward an inside of the rail opening; and
a bearing connected to a door arm is seated on the protrusion and is configured to roll.

4. The vehicle-body-integrated rail structure of claim 2, wherein:
the center cross member connection part has a shape that is concave toward a lower side of the vehicle body and is connected to and overlaps an end of the center cross member; and
an end of the center cross member connection part is connected to the end of the center cross member by a blind rivet.

5. The vehicle-body-integrated rail structure of claim 2, wherein:
each of the vehicle body connection parts has a stepped tunnel shape and is connected to and overlaps an end of the vehicle body; and
the vehicle body is inserted into and connected to an inside of the stepped tunnel shape of the vehicle body connection parts.

6. The vehicle-body-integrated rail structure of claim 5, wherein:
an upper side of the vehicle body is coupled to an upper side of the vehicle body connection parts by a self-piercing rivet; and
a lower side of the vehicle body is coupled to a lower side of the vehicle body connection parts by a blind rivet.

7. The vehicle-body-integrated rail structure of claim 2, wherein:
the pillar connection part has a stepped tunnel shape and is connected to and overlaps an end of a B-pillar and an end of a C-pillar;
the B-pillar is inserted into and connected to an inside of the stepped tunnel shape of the pillar connection part;
an outer side of the B-pillar is connected to an outer side of the pillar connection part by a flow drill screw;
an inner side of the B-pillar is connected to an inner side of the pillar connection part by a blind rivet;
the C-pillar is inserted into and connected to the inside of the stepped tunnel shape of the pillar connection part; and
the C-pillar is coupled to the inside of the stepped tunnel shape of the pillar connection part by a self-piercing rivet.

8. The vehicle-body-integrated rail structure of claim 1, wherein the upper rail comprises:
a rail part in which the rail opening extends in a longitudinal direction of the vehicle body;
a pillar connection part extending from the rail part toward a lower side of the vehicle body and connected to a pillar;
a roof rail connection part extending from an upper end of the rail part toward a central portion of the vehicle body and connected to a roof rail of the vehicle body; and
a vehicle body connection part extending from the upper end of the rail part in the longitudinal direction of the vehicle body and connected to the vehicle body.

9. The vehicle-body-integrated rail structure of claim 1, wherein the center rail comprises:
a rail part in which the rail opening extends in a longitudinal direction of the vehicle body;
a first pillar connection part extending from a first end of the rail part toward upper and lower sides of the vehicle body and connected to a C-pillar of the vehicle body; and
a second pillar connection part extending from a second end of the rail part toward a rear side of the vehicle body.

10. The vehicle-body-integrated rail structure of claim 9, wherein the first pillar connection part comprises:
a first upper pillar connection part extending from an end of the rail part toward an upper side of the vehicle body and connected to an upper portion of the C-pillar; and
a first lower pillar connection part extending from the end of the rail part toward a lower side of the vehicle body and connected to a lower portion of the C-pillar.

11. The vehicle-body-integrated rail structure of claim 10, wherein a closed cross-section portion configured as a cross-shaped bead is disposed between the first upper pillar connection part and the first lower pillar connection part.

12. A vehicle comprising:
a vehicle body comprising a door opening portion, a sliding door coupled to the vehicle body, and a center cross member;
a vehicle-body-integrated rail structure disposed in the door opening portion, the vehicle-body-integrated rail structure comprising:
an upper rail disposed at an upper side of the door opening portion;
a center rail disposed at a vehicle body rear center side of the door opening portion; and
a lower rail disposed at a vehicle body lower side of the door opening portion, wherein rail openings are disposed in the upper rail and the lower rail and define sliding movement routes for the sliding door.

13. The vehicle of claim 12, wherein the lower rail comprises:
a rail part in which the rail opening is disposed in a longitudinal direction of the vehicle body;
a pillar connection part extending from the rail part toward an upper side of the vehicle body and connected to a pillar;
a center cross member connection part extending from a lower end of the rail part toward a central portion of the vehicle body and connected to the center cross member of the vehicle body; and
vehicle body connection parts extending from lower ends of two opposite sides of the rail part in the longitudinal direction of the vehicle body and connected to the vehicle body.

14. The vehicle of claim 13, wherein:
a protrusion is disposed on an inner surface of a lower portion of the rail opening and protrudes toward an inside of the rail opening; and
a bearing connected to a door arm is seated on the protrusion and is configured to roll.

15. The vehicle of claim 13, wherein:
the center cross member connection part has a shape that is concave toward a lower side of the vehicle body and is connected to and overlaps an end of the center cross member; and
an end of the center cross member connection part is connected to the end of the center cross member by a blind rivet.

16. The vehicle of claim 13, wherein:
each of the vehicle body connection parts has a stepped tunnel shape and is connected to and overlaps an end of the vehicle body; and
the vehicle body is inserted into and connected to an inside of the stepped tunnel shape of the vehicle body connection parts.

17. The vehicle of claim 16, wherein:
an upper side of the vehicle body is coupled to an upper side of the vehicle body connection parts by a self-piercing rivet; and
a lower side of the vehicle body is coupled to a lower side of the vehicle body connection parts by a blind rivet.

18. The vehicle of claim 13, wherein:
the pillar connection part has a stepped tunnel shape and is connected to and overlaps an end of a B-pillar and an end of a C-pillar;
the B-pillar is inserted into and connected to an inside of the stepped tunnel shape of the pillar connection part;
an outer side of the B-pillar is connected to an outer side of the pillar connection part by a flow drill screw;
an inner side of the B-pillar is connected to an inner side of the pillar connection part by a blind rivet;
the C-pillar is inserted into and connected to the inside of the stepped tunnel shape of the pillar connection part; and
the C-pillar is coupled to the inside of the stepped tunnel shape of the pillar connection part by a self-piercing rivet.

19. The vehicle of claim 12, wherein the upper rail comprises:
a rail part in which the rail opening extends in a longitudinal direction of the vehicle body;
a pillar connection part extending from the rail part toward a lower side of the vehicle body and connected to a pillar;
a roof rail connection part extending from an upper end of the rail part toward a central portion of the vehicle body and connected to a roof rail of the vehicle body; and
a vehicle body connection part extending from the upper end of the rail part in the longitudinal direction of the vehicle body and connected to the vehicle body.

20. The vehicle of claim 12, wherein the center rail comprises:
a rail part in which the rail opening extends in a longitudinal direction of the vehicle body;
a first pillar connection part extending from a first end of the rail part toward upper and lower sides of the vehicle body and connected to a C-pillar of the vehicle body; and
a second pillar connection part extending from a second end of the rail part toward a rear side of the vehicle body.
